(19) United States
(12) Patent Application Publication
(10) Pub. No.: US 2014/0125958 A1
(43) Pub. Date: May 8, 2014

(54) PROJECTOR WITH DISSIPATIION SINKS AND FAN

(71) Applicant: HON HAI PRECISION INDUSTRY CO., LTD., New Taipei (TW)

(72) Inventors: MING-CHIH SUN, New Taipei (TW); KAI HUANG, New Taipei (TW)

(73) Assignee: HON HAI PRECISION INDUSTRY CO., LTD., New Taipei (TW)

(21) Appl. No.: 13/873,243

(22) Filed: Apr. 30, 2013

(30) Foreign Application Priority Data
Nov. 2, 2012 (TW) 101140730

(51) Int. Cl. G03B 21/16

(52) U.S. Cl. CPC G03B 21/16
USPC 353/57

(57) ABSTRACT

A projector includes a case, a light emitting module, a light projecting module, two dissipation sinks, and a fan. The case includes a right sidewall and a left sidewall opposite to the right sidewall. The right sidewall defines an air inlet, and the left sidewall defines an air outlet opposite to the air inlet. The light emitting module includes a light source emitting light rays. The light projecting module includes a digital micro device (DMD) reflecting the light rays emitted from the light emitting module. The two dissipation sinks are positioned between the air inlet and the left inlet, one of the dissipation sinks is attached on the light source, and another dissipation sink is attached on the DMD. The fan is positioned between the air inlet and the air outlet.

### BACKGROUND

1. Technical Field

The present disclosure relates to projectors and, particularly, to a projector capable of effectively dissipating heat.

2. Description of Related Art

Projectors need more than one fan for dedicating heat dissipation of various heat sources, such as light source and spatial light modulators, which increases the size and the cost of the projector and generates more noise.

Therefore, it is desirable to provide a projector, which can overcome the limitations described.

### BRIEF DESCRIPTION OF THE DRAWINGS

FIG. 1 is a schematic view of a projector in accordance with a first exemplary embodiment.

FIG. 2 is a schematic view of a projector in accordance with a second exemplary embodiment.

FIG. 3 is a schematic view of a projector in accordance with a third exemplary embodiment.

### DETAILED DESCRIPTION

Embodiments of the disclosure will be described with reference to the drawings.

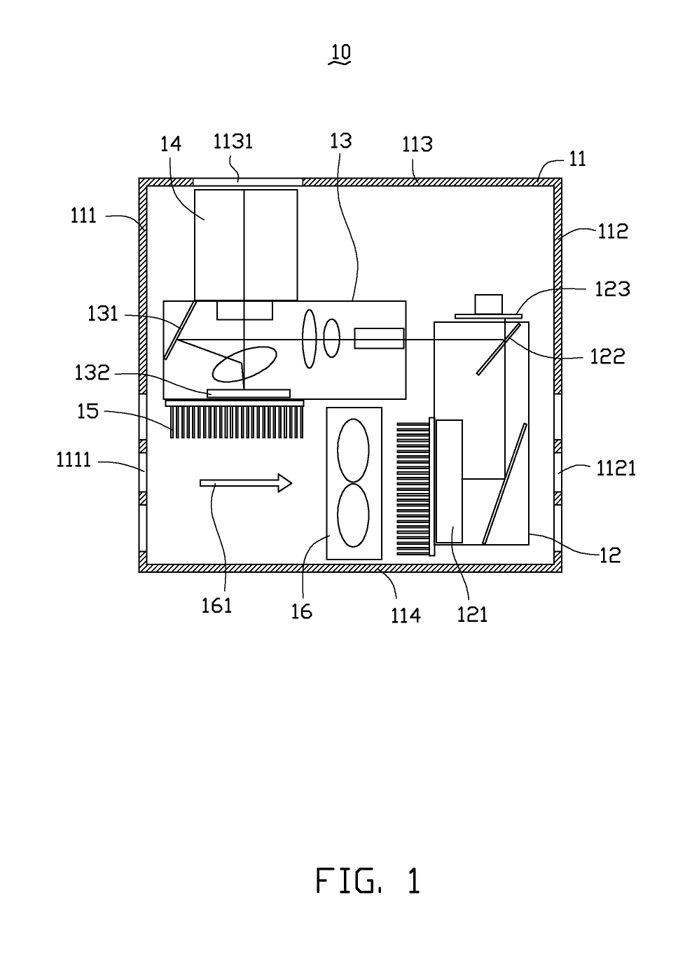

FIG. 1 shows a projector 10 according to a first exemplary embodiment. The projector 10 includes a case 11, a light emitting module 12, a light projecting module 13, a lens 14, two dissipation sinks 15, and a fan 16. In this embodiment, the projector 10 is a digital light processor (DLP) projector.

The case 11 is a cuboid and includes a first sidewall such as a left sidewall 111, a second sidewall such as a right sidewall 112, a third sidewall such as a front sidewall 113, and a fourth sidewall such as a rear sidewall 114. The left sidewall 111 is opposite to the right sidewall 112, and the front sidewall 113 is opposite to the rear sidewall 114. The left sidewall 111 and the right sidewall 112 are respectively connected between the front sidewall 113 and the rear sidewall 114. The left sidewall 111 defines an air inlet 1111, and the right sidewall 112 defines an air outlet 1121. The air inlet 1111 is aligned with the air outlet 1121. The front sidewall 113 defines a through hole 1131, generally adjacent to the left sidewall 111.

The light emitting module 12 is received in the case 11, generally adjacent to the right sidewall 112. The light emitting module 12 includes a light source 121, a first optical group 122, and a RGB fluorescence wheel 123. The light source 121 faces the air outlet 1121. The RGB fluorescence wheel 123 faces the rear sidewall 114. The first optical group 122 is positioned between the light source 121 and the RGB fluorescence wheel 123. A direction of light rays emitted from the light source 121 is perpendicular to the right sidewall 112, and the light rays penetrate the first optical group 122 and project on the RGB fluorescence wheel 123. The RGB fluorescence wheel 123 is excited by the light rays projected thereon, and emits red light rays, green light rays, and blue light rays to the first optical group 122. The first optical group 122 reflects the red light rays, the green light rays, and the blue light rays toward the left sidewall 111. In the embodiment, the light source 121 is a laser source emitting a mono-color laser or a multi-color laser.

The light projecting module 13 is received in the case 11, and is positioned between the light emitting module 12 and the left sidewall 111. The light projecting module 13 includes a second optical group 131 and a digital micro device (DMD) 132. The second optical group 131 faces the first optical group 122. The DMD 132 faces the through hole 1131. The second optical group 131 is positioned between the first optical group 122 and the DMD 132. The light rays emitted from the first optical group 122 are projected into the second optical group 131. The light rays are reflected to the DMD 132, and the DMD 132 reflects the light rays toward the front sidewall 113.

The lens 14 is received in the case 11, and is positioned between the light projecting module 13 and the front sidewall 113. The lens 14 penetrates from the through hole 1131. The light rays emitted from the DMD 132 are projected to the lens 14. The light rays penetrate the lens 14 and projects on a screen (not shown).

The dissipation sinks 15 are received in the case 11, and are positioned between the air inlet 1111 and the air outlet 1121. One of the dissipation sinks 15 is attached on the light source 121, and faces the air inlet 1111. Another dissipation sink 15 is attached on the DMD 132, and faces the rear sidewall 114. In this embodiment, an extending direction of the dissipation sink 15 attached on the light source 121 is parallel with the left sidewall 111 and the right sidewall 112, an extending direction of the dissipation sink 15 attached on the DMD 132 is perpendicular to the left sidewall 111 and the right sidewall 112.

The fan 16 is received in the case 11, and is positioned between the air inlet 1111 and the air outlet 1121. The fan 16 faces the air outlet 1121. In the embodiment, the fan 16 is adjacent to a middle of the left sidewall 111 and a middle of the right sidewall 112. The fan 16 is positioned between the two dissipation sinks 15. The fan 16 is an aerofoil fan. The air inlet 1111, the fan 16, and the air outlet 1121 form a dissipating passage 161. A cool air is sucked into the case 11 from the air inlet 111 by the fan 16, and a heat air is blown out the case 11 via the air outlet 1121 by the fan 16.

In use, heat generated by the light source 121 and the DMD 132 is dissipated (e.g., conducted) by the dissipation sinks 15. The heat air is sucked from the air outlet 1121 and the cool air is drawn in from the air inlet 1111 under the movement of the fan 16. Therefore, the light source 121 and the DMD 132 positioned in the dissipating passage 161 can be cooled immediately.

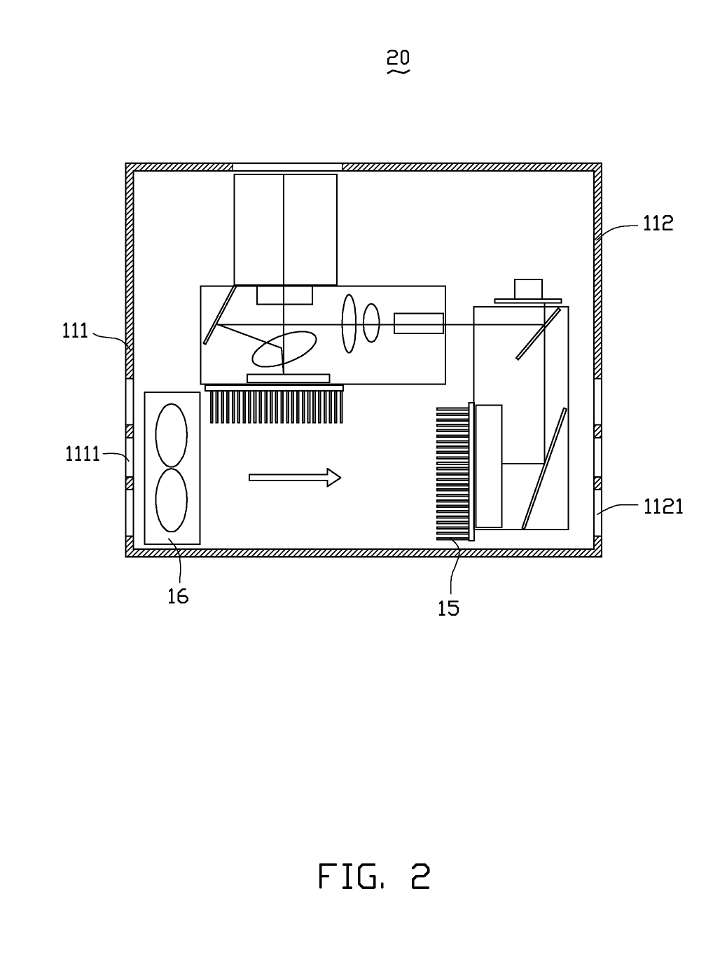

FIG. 2 shows a projector 20 according to a second exemplary embodiment. The difference between the projector 20 of the second exemplary embodiment and the projector 10 of the first exemplary embodiment is that the fan 16 is positioned adjacent to the air inlet 1111. In the embodiment, the fan 16 is positioned between the left sidewall 111 and the dissipation sink 15 attached on the DMD 132.

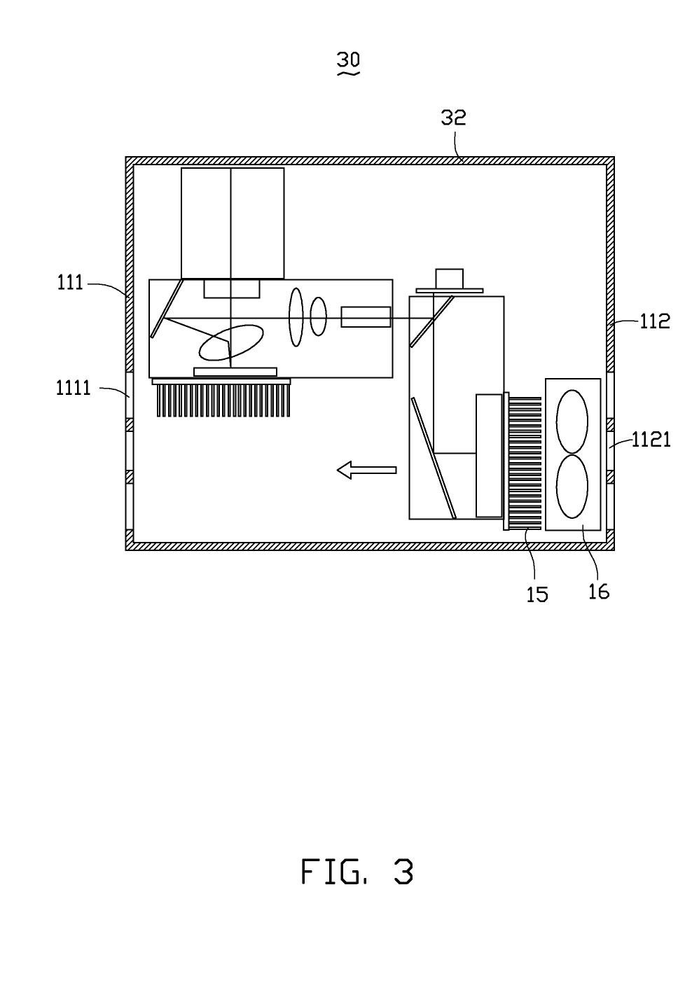

FIG. 3 shows a projector 30 according to a third exemplary embodiment. The difference between the projector 30 of the third exemplary embodiment and the projector 10 of the first exemplary embodiment is that the fan 16 is positioned adjacent to the air outlet 1121. In the embodiment, the fan 16 is positioned between the right sidewall 112 and the light emitting module 12.

Particular embodiments are shown and are described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A projector, comprising:
a case comprising a right sidewall and a left sidewall opposite to the right sidewall, the right sidewall defining an air inlet, the left sidewall defining an air outlet opposite to the air inlet;
a light emitting module comprising a light source emitting light rays;
a light projecting module comprising a digital micro device (DMD) reflecting the light rays emitted from the light emitting module;
two dissipation sinks positioned between the air inlet and the left inlet, one of the dissipation sinks attached on the light source, another dissipation sink attached on the DMD; and
a fan positioned between the air inlet and the air outlet.

2. The projector of claim 1, wherein the case comprises a front sidewall and a rear sidewall, the left sidewall and the right sidewall are respectively connected between the front sidewall and the rear sidewall, the front sidewall defines a thought hole.

3. The projector of claim 2, wherein the light source faces the air outlet, and the DMD faces the through hole.

4. The projector of claim 1, wherein an extending direction of the dissipation sink attached on the light source is parallel with the left sidewall and the right sidewall, an extending direction of the dissipation sink attached on the DMD is perpendicular to the left sidewall and the right sidewall.

5. The projector of claim 1, wherein the air inlet, the fan, and the air outlet form a dissipating passage, and the two dissipation sinks are positioned in the dissipating passage.

6. The projector of claim 1, wherein the fan is position between the two dissipation sinks.

7. The projector of claim 1, wherein the fan is positioned between the left sidewall and the dissipation sink attached on the DMD.

8. The projector of claim 1, wherein the fan is positioned between the right sidewall and the light emitting module.
